(19) United States
(12) Patent Application Publication
(10) Pub. No.: US 2020/0316992 A1
(43) Pub. Date: Oct. 8, 2020

(54) ARRANGEMENT OF A BEARING COMPONENT ON A CHASSIS COMPONENT, BEARING COMPONENT AND CHASSIS COMPONENT FOR SUCH AN ARRANGEMENT AND METHOD OF MANUFACTURING THEM

(71) Applicant: Hirschvogel Umformtechnik GmbH, Denklingen (DE)

(72) Inventor: Hans-Willi RAEDT, Buchloe (DE)

(21) Appl. No.: 16/829,453

(22) Filed: Mar. 25, 2020

(30) Foreign Application Priority Data
Apr. 4, 2019 (DE) 10 2019 108 836.4

(51) Int. Cl. B60B 35/00

(52) U.S. Cl. CPC B60B 35/004; B60B 35/18

(57) ABSTRACT

With an arrangement of a bearing component on a chassis component, in particular on a wheel carrier, it is possible for a wheel of a vehicle to be mounted on the chassis component so as to be rotatable about an axis of rotation by the bearing component. The bearing component has at least one first form-fitting element disposed on the bearing component side and the chassis component has at least one first form-fitting element on the chassis component side. In order to prevent relative rotation along an orbital direction between the bearing component and the chassis component, the at least one first form-fitting element disposed on the bearing component side interacts positively with the at least one first form-fitting element disposed on the chassis component side in the assembled state along the orbital direction.

### CROSS-REFERENCE TO RELATED APPLICATIONS

This application is related to, and claims the benefit of, German patent application no. DE 10 2019 108 836.4, filed on Apr. 4, 2019, the contents of which are hereby incorporated by reference in their entirety.

### TECHNICAL FIELD

The present disclosure relates to an arrangement of a bearing component on a chassis component, a bearing component and a chassis component for such an arrangement, and a method of producing them.

### BACKGROUND

Chassis components, in particular as wheel carriers or pivot bearings, are sufficiently known from the state of the art, for example from DE 10 2015 204 739 A1. Wheel carriers, for example as pivot bearings, are typically used to ensure a wheel suspension in a vehicle. Usually, an axle or stub axle is held by the wheel carrier and a damped connection to a vehicle body is realized via the wheel carrier.

Typically, a bearing component is connected to the wheel carrier, in particular screwed to the wheel carrier, so that the axle or stub axle can be mounted so that it rotates about an axis of rotation. For this purpose, the wheel carrier usually has a recess in or on which the bearing component is attached. It has been found that during operation there can be a twist between the bearing component and the chassis component, which in turn can lead to a so-called wheel bearing cracking.

### SUMMARY

Based on the above-mentioned state of the art, the present disclosure provides an improved arrangement of chassis component and bearing component compared to the state of the art, in particular an improved arrangement with regard to noise generation.

Further advantages and features of the disclosure result from the claims as well as the description and the attached figures.

According to a first aspect of the present disclosure, an arrangement of a bearing component is provided on a chassis component, in particular on a wheel carrier, it being possible for a wheel of a vehicle to be mounted on the chassis component so as to be rotatable about an axis of rotation by means of the bearing component, the bearing component having at least one first form-fitting means on the bearing component side and the chassis component having at least one first form-fitting means on the chassis component side, wherein, in order to prevent relative rotation along an orbital direction between the bearing component and the chassis component, the first form-fitting means on the bearing component side interacts positively with the first form-fitting means on the chassis component side in the assembled state along the orbital direction.

In contrast to the state of the art, the arrangement according to the disclosure provides that the additionally formed first form-fitting means on the bearing component side and the first form-fitting means on the chassis component side interact positively with each other in the direction of rotation. As a result, twisting of the bearing component along the direction of rotation is prevented or minimized so that wheel bearing cracking can be avoided. In particular, the orbital direction is parallel to a rotational movement or direction in relation to the axis of rotation, i.e. to a rotational movement around the axis of rotation. In other words: the orbital direction essentially follows or runs parallel to the general course of the outermost circumference of the bearing component in a plane perpendicular to the axis of rotation.

Preferably, the bearing component should be shaped in the form of a ring or annular disc. Thereby, the bearing component forms, for example, an outer ring of a rolling bearing, in particular in such a way that an inner side of the bearing component provides the raceway for the rolling elements of the corresponding rolling bearing. For example, the bearing component is designed to provide two raceways offset along the wheel axis, allowing two sets of rolling elements to be used side by side for the rotating support of an axle or stub axle. Furthermore, it is preferably provided that in the assembled state the bearing component engages or is recessed in a corresponding reception area of the chassis component, in particular engaging by more than 30%, preferably by more than 40° and particularly preferably by more than 45% in the reception area.

Preferably, the chassis component is a wheel carrier or a pivot bearing which is used to connect an axle or stub axle to the vehicle body. As a component of a rolling bearing, the bearing component ensures, for example, that the axle or axle stub is rotatably mounted on the chassis component. In particular, the first form-fitting means on the bearing component side are spaced apart from one another in the direction of rotation, in particular further apart than an extension of the first form-fitting means on the bearing component side dimensioned in the orbital direction. In other words: the first form-fitting means on the bearing component side are not arranged adjacent to each other, but are deliberately offset at fixed distances from each other. Preferably, it is intended that the first form-fitting means on the bearing component side is shaped or formed in the immediate vicinity, in particular adjacent to a bore on the bearing component side. For example, the bore on the bearing component side is formed between two first form-fitting means on the bearing component side. The connection to the chassis component is preferably made via the bore on the bearing side. Due to the comparatively close arrangement of the first form-fitting means on the bearing component side, the form-fitting means on the bearing component side are arranged in the immediate vicinity of the area that is significantly responsible for the noise generation, i.e. the wheel bearing cracking.

Preferably it is provided that the bearing component has at least one second form-fitting means on the bearing component side and the chassis component has at least one second form-fitting means on the chassis component side, wherein, in order to prevent relative rotation along the orbital direction between the bearing component and the chassis component, the at least one second form-fitting means on the bearing side interacts positively with the at least one second form-fitting means on the chassis component side in the assembled state along the orbital direction, wherein preferably the first form-fitting means on the bearing component side differs from the second form-fitting means on the bearing side and/or the first form-fitting means on the chassis component side differs from the second form-fitting means on the chassis component side. For example, the first and the second form-fitting means may differ in terms of dimension, shape, material and/or finishing. In this way, the effect on or prevention of twisting can be optimised and adapted to the corresponding requirements of the respective application.

In particular, it is provided that the first form-fitting means, i.e. the first form-fitting means on the bearing component side and/or the first form-fitting means on the chassis component side, or the second form-fitting means, i.e. the second form-fitting means on the bearing component side and/or the second form-fitting means on the chassis component side, are arranged regularly or irregularly when viewed in the orbital direction. Preferably, the first form-fitting means and/or the second form-fitting means are each grouped. For example, it is conceivable that between a first group of first form-fitting means and a group of second form-fitting means a group of second form-fitting means and/or no second form-fitting means is arranged. In particular, it is intended that the first form-fitting means on the bearing side are shaped complementarily to the first form-fitting means on the chassis component side. The same applies to the second form-fitting means on the bearing component side and the second form-fitting means on the chassis component side. For example, the first form-fitting means on the bearing component side is an elevation which engages in a corresponding bulge or indentation, this indentation forming the first form-fitting means on the chassis component side. The first form-fitting means on the bearing component side on the bearing component can be formed as an elevation or bulge.

It is preferably provided that the first form-fitting means, i.e. the first form-fitting means on the bearing component side and/or the first form-fitting means on the chassis component side, and the second form-fitting means, i.e. the second form-fitting means on the bearing component side and/or the second form-fitting means on the chassis component side, tapers an elevation, preferably in a direction running parallel to the axis of rotation, and/or an indentation, preferably tapered in an axis running parallel to the axis of rotation. By means of a corresponding taper it is possible in an advantageous way that the form-fitting means, in particular the first form-fitting means on the bearing side and the first form-fitting means on the chassis component side, serve as a guide and support the alignment of the bearing component during its assembly. This means that when the bearing component is inserted, the first form-fitting means on the bearing component side and the first form-fitting means on the chassis component side ensure alignment of the bearing component, in which the bore on the bearing component side is aligned with the bore on the chassis component side in the chassis component along a direction parallel to the axis of rotation. For example, the first and/or second form-fitting means have a triangular, trapezoidal or a curved or bent cross-section in a sectional plane perpendicular to the radial direction. An advantageous embodiment provides that elevations are formed exclusively in the bearing component and the form-fitting means on the chassis component side are formed exclusively as an indentation. This proves to be advantageous during the manufacturing process, especially when forging the bearing component and the chassis component.

In particular, it is provided that the bearing component has a sleeve-shaped central region and a collar element projecting radially from the central region with respect to the axis of rotation, wherein the first form-fitting means on the bearing component side and/or the second form-fitting means on the bearing component side project from the collar element along a direction running parallel to the axis of rotation. The collar element thus extends essentially in a plane perpendicular to the axis of rotation. This makes it possible in an advantageous way to provide a contact surface in contact with the chassis component, which is comparatively large and includes the first form-fitting means on the bearing component side. This provides an optimum force distribution for counteracting a rotation. In particular, the form-fitting means can be dimensioned accordingly large, so that twisting of the bearing component in relation to the chassis component is not to be expected. In particular, the first form-fitting means and second form-fitting means on the top or bottom of the collar element can be produced comparatively easily. In particular, the first form-fitting means on the bearing component side are arranged on that side of the collar element which faces the chassis component in the assembled state.

Furthermore, it is preferably provided that the bearing component has a first height dimensioned parallel to the axis of rotation and the first form-fitting means and/or the second form-fitting means protrudes with a second height relative to the collar element in the direction of the axis of rotation, wherein a ratio of the second height to the first height assumes a value between 0.1 and 0.3, preferably between 0.15 and 0.25 and particularly preferably between 0.16 and 0.2. This provides a first form-fitting means that protrudes comparatively far from the collar element. For example, several first form-fitting means on the bearing component side form a kind of Hirth joint, via which a corresponding interaction with the contact surface of the chassis component is achieved.

In a further preferred embodiment of the present disclosure it is provided that the collar element has a third height in a direction parallel to the axis of rotation, a ratio of the second height to the third height assuming a value between 0.3 and 0.8, preferably between 0.4 and 0.7 and particularly preferably between 0.4 and 0.6. It turned out to be advantageous that a correspondingly stable collar element can be accomplished, which also counteracts twisting in the desired manner, whereby material and corresponding weight can be saved on the bearing component due to the comparatively thin collar element.

Furthermore, it is preferably provided that a radial extent of the collar element varies along the orbital direction. In particular, the extent of the collar element in the radial direction varies in such a way that flange areas are formed in which the bores on the bearing side are formed on the bearing component. In particular, such flanges are limited by the first form-fitting means on the bearing component side, i.e. the first form-fitting means on the bearing component side is implemented in the flange area, so that the first form-fitting means on the bearing component side can extend or extends in the radial direction over the full extent of the collar element.

Furthermore, it is particularly preferred that the second form-fitting means on the bearing component side is located in an area with a reduced extent of the collar element compared to the areas with the bore on the bearing component side. Preferably, it is intended that the radial extent in a region between two bores on the bearing component side is reduced to up to 50%. Furthermore, it is particularly preferred that the collar element has rounded corner areas to avoid possible injuries during assembly. Furthermore, it is preferably provided that the collar element and the sleeve-shaped central region of the bearing component are designed in one piece or integrally. One-piece” means in particular that the bearing component cannot be dismantled non-destructively into further individual components. Furthermore, it is particularly preferred that the first form-fitting means on the bearing component side extend essentially radially in relation to the axis of rotation. It is also conceivable that the first form-fitting means on the bearing component side are formed obliquely or at an angle to the radial direction, with the angle assuming a value between 0 and 45°, preferably between 5° and 40° and particularly preferably between 10° and 30°.

Another aspect of the present disclosure is a bearing component for an arrangement according to the disclosure. All characteristics and advantages described for the arrangement apply analogously to the bearing component and vice versa.

A further subject-matter of the present disclosure is a chassis component, in particular a wheel carrier or a pivot bearing for an arrangement according to the disclosure. All characteristics and advantages described for the arrangement can be transferred analogously to the chassis component and vice versa.

The present disclosure provides a method for producing a chassis component and/or a bearing component according to the disclosure, wherein the bearing component and/or the chassis component can be produced by forming, in particular forging. In particular, it has been found that the first and second form-fitting means on the bearing component side can be easily and quickly formed by forging, whereby the formed form-fitting means also provide sufficient stability during operation that is necessary to prevent permanent twisting of the bearing component relative to the chassis component.

### BRIEF DESCRIPTION OF THE DRAWINGS

Further advantages and features result from the following description of preferred embodiments of the subject matter of the disclosure with reference to the attached figures. It is shown in:

FIG. 1: a bearing component according to a preferred embodiment of the present disclosure in a perspective view,

FIG. 2 a chassis component according to a preferred embodiment for a bearing component from FIG. 1 in a perspective view,

FIGS. 3a and 3b a side view and a sectional view of the bearing component from FIG. 1, and

FIGS. 4a and 4b a side view and a sectional view of the chassis component from FIG. 2.

### DETAILED DESCRIPTION OF THE DRAWINGS

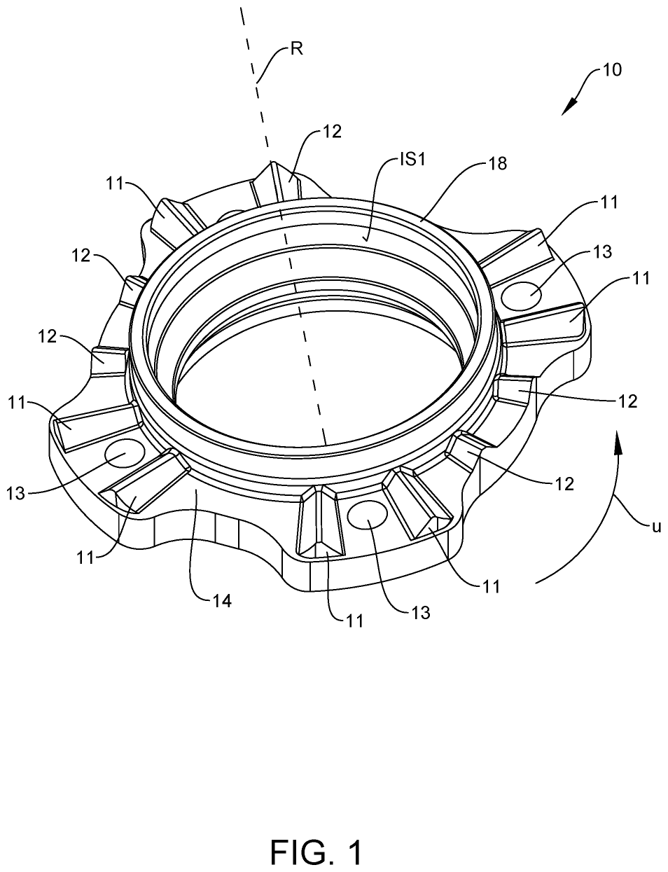

In FIG. 1, a bearing component 10 is illustrated in a perspective view according to a preferred embodiment of the present disclosure. In particular, it is a bearing component 10 which is intended for an arrangement of a bearing component 10 and a chassis component 20 according to a preferred embodiment of the present disclosure, the bearing component 10 being attached to the chassis component 20 in the assembled state. In particular, it is intended that the chassis component 20 is intended for the suspension of a wheel or axle and/or stub axle. In the form of a wheel carrier or pivot bearing, chassis component 20 is used to connect a wheel to a vehicle body. For this purpose, for example, chassis component 20 can be connected to the vehicle body via a damping unit, e.g. a vibration damper.

By means of bearing component 10, it is then intended to provide a possibility for the rotating bearing of the axle or the stub shaft around an axis of rotation R. In the example shown in FIG. 1, the bearing component 10 comprises a sleeve-shaped central region 18 and a collar element 14 projecting radially from the central region 18, the bearing component 10 being connected to the chassis component 20 via the collar element 14, in particular via bores on the bearing component side 13 in the collar element 14, the bores on the bearing component side 13 being in particular uniformly distributed along an orbital direction. In particular, it is intended, for example, that an interior on the bearing component side IS1 is configured in such a way that it provides raceways for rolling elements. For example, the bearing component 10 in FIG. 1 forms an outer ring for a rolling bearing (not shown), wherein, for example, the rolling bearing comprises two sets of rolling elements arranged one above the other or side by side along a direction parallel to the axis of rotation R. Accordingly, the inner face on the bearing component side IS1 of the bearing component 10 is configured to form two raceways.

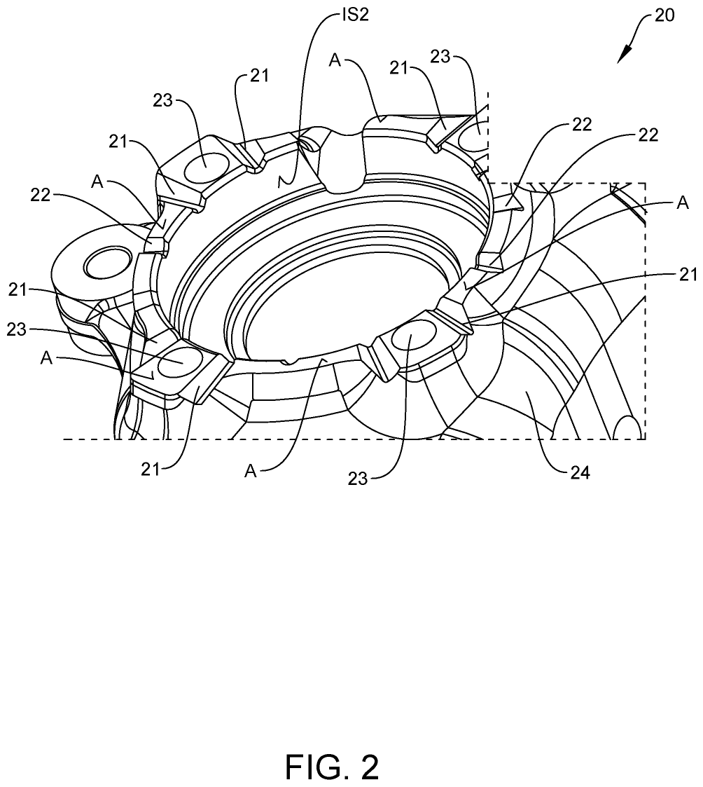

FIG. 2 shows a chassis component 20 according to a preferred embodiment of the present disclosure. In particular, it is the chassis component 20 which, together with the bearing component 10 in FIG. 1, enables the arrangement of a bearing component 10 on a chassis component 20 according to a preferred embodiment of the present disclosure. In particular, it is intended that the chassis component 20 has an inner area on the chassis component side IS2, which is designed in particular as a pot-shaped reception area 26, in which in turn the bearing component 10 at least partially engages in the assembled state. The pot-shaped reception area 26 extends essentially along a main plane of extension HSE. In particular, the bearing component 10 is inserted with one of its end faces into the pot-shaped reception area 26 (along a direction perpendicular to the main plane of extension HSE) and the collar element 14 of the bearing component 10 rests in the assembled state on a wall delimiting the reception area 26, in particular on a contact surface A of the chassis component 20. In particular, it is intended that bores on the chassis component side 23 are recessed in the contact surface A of the chassis component 20, which in the assembled state are aligned with the holes on the bearing component side 13 along a direction parallel to the axis of rotation R. Accordingly, a connection can be made between the bearing component 10 and the chassis component 20 by means of an appropriate fastening means, in particular a screw or bolt, by the appropriate fastening means passing through the bore on the bearing component side 13 and bore on the chassis component side 23 that are arranged in alignment with each other.

In order to prevent the bearing component 10 from rotating relative to the chassis component 20 along the orbital direction U during operation and thereby causing a so-called wheel bearing cracking, it is provided that the bearing component 10 has at least one first form-fitting means on the bearing component side 11. This at least one first form-fitting means on the bearing side 11 interacts in the assembled state of the arrangement with a preferably complementarily shaped at least one first form-fitting means on the chassis component side 21, whereby twisting along the orbital direction U relative to the axis of rotation R of the bearing component 10 can be prevented in an advantageous manner.

In the embodiment of FIGS. 1 and 2, the first form-fitting means on the bearing component side 11 is formed as a roof-shaped elevation which is arranged on the collar element 14 and extends radially outwards, in particular with a constant cross-section, and tapers with increasing distance from the collar element 14. The first form-fitting means on the chassis component side 21 is a correspondingly complementary shaped indentation or notch in the contact surface A of the chassis component 20. In the assembled state, the elevation of the bearing component 10, i.e. the first form-fitting means on the bearing component side 21, then engages in the corresponding indentation of the chassis component 20, i.e. in the first form-fitting means on the chassis component side 22, in order to ensure the corresponding positive interaction along the orbital direction U.

Preferably, two first form-fitting means on the bearing component side 11 are arranged adjacent to the bore on the bearing component side 13, in particular on opposite sides, and in particular arranged directly adjacent. Preferably a distance dimensioned along the orbital direction U from the bore on the bearing component side 13 to the adjacent first form-fitting means on the bearing component side 11 is smaller than an extension of the first form-fitting means on the bearing component side 11 in the direction of the orbital direction U. Accordingly, the first form-fitting means on the bearing component side 11 is arranged comparatively close to the bore on the bearing component side 13 and is thus formed in the area that is mainly responsible for the formation of the wheel bearing cracking.

In the example shown in FIGS. 1 and 2, it is provided that in addition to the first form-fitting means on the bearing component side 11 and the first form-fitting means on the chassis component side 21, there is a second form-fitting means on the bearing component side 12 and a second form-fitting means on the chassis component side 22, wherein the first form-fitting means on the bearing component side 11 is different from the second form-fitting means on the bearing component side 12 and the second form-fitting means on the chassis component side 21 from the second form-fitting means on the chassis component side 22. For example, the form-fitting means 11, 12, 21, 22 differ in terms of dimensioning, for example in the radial direction and/or along an extension parallel to the axis of rotation R, in terms of material and/or in terms of finishing.

In the area shown in FIG. 1, the second form-fitting means on the bearing component side 12 are also formed as elevations, but these are formed or shaped in an area of the collar element 14, the outermost edge of which, viewed in the radial direction, is set back in relation to the areas of the collar element 14 that comprise the bore on the bearing component side 13. In particular, it is envisaged that the collar element 14 will vary its extent at its outermost circumference, particularly in the radial direction. This allows material to be saved in the areas between the bore on the bearing component side 13 or the flange-like sections of the collar element 14 with the bores on the bearing side 13, which has a positive effect on the total weight of the bearing component 10. It is also intended that there are more first form-fitting means on the bearing component side 11 than second form-fitting means on the bearing component side 12. For example, it is intended that there is a section of the collar element 14, viewed in the orbital direction U, in which no second form-fitting means on the bearing component side 12 is formed between two bores on the bearing component side 13.

Furthermore, it is provided that the first form-fitting means 11, 21, in particular the first form-fitting means on the bearing component side 11, are spaced apart from each other as viewed in the orbital direction U, i.e. are not arranged directly one after the other. Instead, a distance dimensioned in the orbital direction U between two first form-fitting means 11, 12 or two groups of form-fitting means 11, 12 is greater, in particular more than 1.5 times, preferably more than 2 times and particularly preferably more than 3.5 times greater than an extension of the first form-fitting means 11, 21 dimensioned in the orbital direction U. Furthermore, it is preferably provided that the first form-fitting means on the bearing component side 11 delimit a flange area by means of which the bearing component 10 is connected to the chassis component 20 and which is characterised in particular by the fact that it forms an area which protrudes or projects radially outwards in relation to the remaining course of the collar element 14.

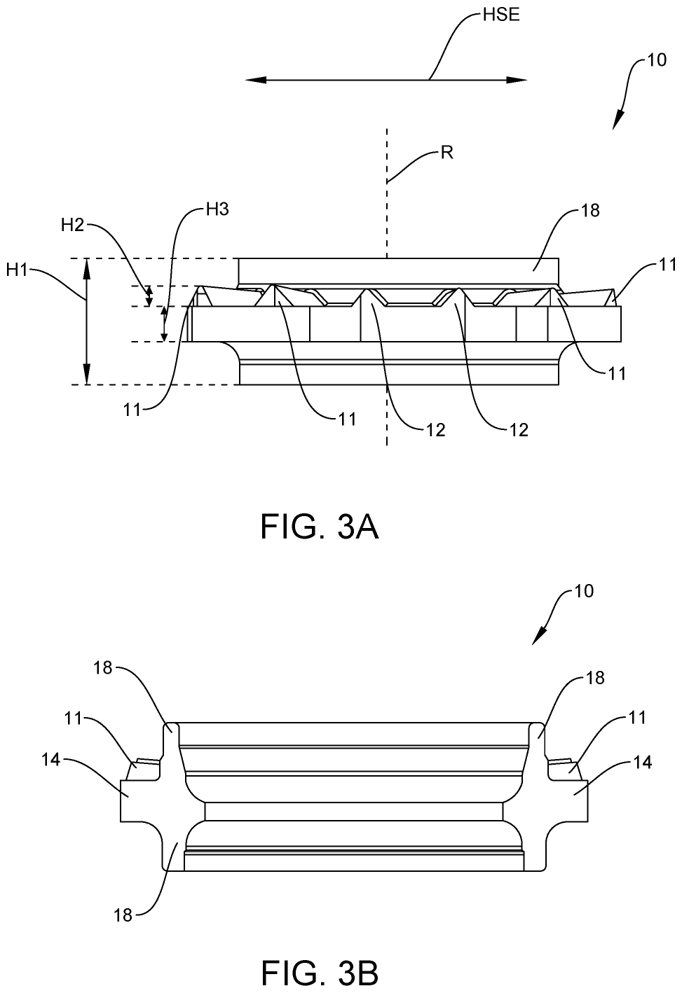

In FIGS. 3a and 3b, the bearing component 10 is shown in a side view (see FIG. 3a) and in a sectional view (see FIG. 3b). In particular, it is intended that the collar element 14, viewed in a direction parallel to the axis of rotation R, is formed centrally, i.e. at half height, on the outside of the sleeve-shaped central region 18. In particular, it is intended that the central region 18 has a first height H1 in a direction parallel to the axis of rotation R, the collar element 14 has a third height H3 and the first and second form-fitting means on the bearing component side 11, 12 have a second height H2. In particular, it is envisaged that a ratio between the second height H2 and the third height H3 will have a value between 0.3 and 0.8, preferably between 0.4 and 0.7 and particularly preferably between 0.45 and 0.6. As a result, a correspondingly large elevation is formed as form-fitting means on the bearing component side 11,12, which ensures sufficient and effective form-fitting between bearing component 10 and chassis component 20 to prevent wheel bearing cracking. Furthermore, it is preferably provided for the ratio of the second height H2 to the first height H1 to assume a value between 0.1 and 0.3, preferably between 0.1 and 0.25 and particularly preferably between 0.16 and 0.2.

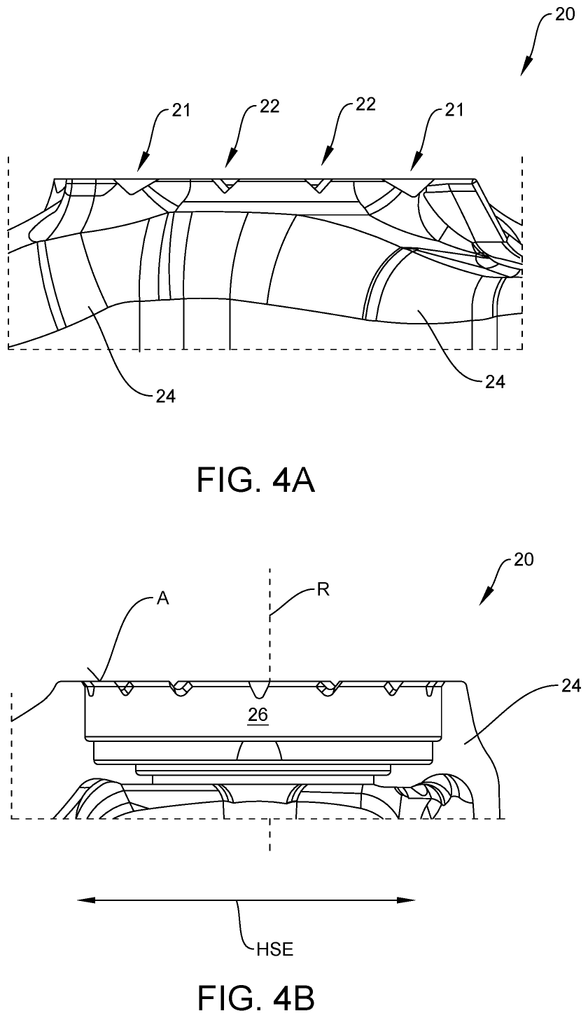

FIGS. 4a and 4b show the chassis component 20 in a side view (see 4a) and in a sectional view (see 4b). In particular, the sectional view shows the pot-shaped reception area 26 extending along the main plane of extension HSE, of which, for example, an underside of the bearing component 10 is received by the chassis component 20 in such a way that the collar element 14 rests on the contact surface A in order to ensure that the bearing component 10 is connected to the chassis component 20 in this area. In particular, it is envisaged that the chassis component 20 will have a curved basic body 24, which is in particular designed as a freeform that is optimally suited to the intended use, in particular for the suspension of a wheel or wheel axle.

1. An arrangement of a bearing component on a chassis component, in particular on a wheel carrier, it being possible for a wheel of a vehicle to be mounted on the chassis component so as to be rotatable about an axis of rotation by means of the bearing component, the bearing component comprising at least one first form-fitting means on the bearing component side and the chassis component having at least one first form-fitting means on the chassis component side, wherein, in order to prevent relative rotation along an orbital direction between the bearing component and the chassis component, the at least one first form-fitting means on the bearing component side interacts positively with the at least one first form-fitting means on the chassis component side in the assembled state along the orbital direction.

2. The arrangement according to claim 1, wherein the bearing component has at least one second form-fitting means on the bearing component side and the chassis component has at least one second form-fitting means on the chassis component side, wherein, in order to prevent relative rotation along the orbital direction between the bearing component and the chassis component (20), the at least one second form-fitting means on the bearing component side interacts positively with the at least one second form-fitting means on the chassis component side in the assembled state along the orbital direction, wherein preferably the first form-fitting means on the bearing side differs from the second form-fitting means on the bearing side and/or the first form-fitting means on the chassis-component side differs from the second form-fitting means on the chassis-component side.

3. The arrangement according to claim 1, wherein the first form-fitting means or the second form-fitting means comprises an elevation which preferably tapers in a direction parallel to the axis of rotation and/or an indentation which preferably tapers in a direction parallel to the axis of rotation.

4. The arrangement according to claim 1, wherein the bearing component has a sleeve-shaped central region and a collar element projecting radially from the central region with respect to the axis of rotation, wherein the first form-fitting means on the bearing component side and/or the second form-fitting means on the bearing side project from the collar element along a direction running parallel to the axis of rotation.

5. The arrangement according to claim 1, wherein the bearing component has a first height dimensioned parallel to the axis of rotation and the first form-fitting means on the bearing side and/or the second form-fitting means on the bearing side protrudes by a second height relative to the collar element in the direction of the axis of rotation, wherein a ratio of the second height to the first height assumes a value between 0.1 and 0.3, preferably between 0.15 and 0.25 and particularly preferably between 0.16 and 0.2.

6. The arrangement according to claim 1, the collar element having a third height in a direction parallel to the axis of rotation, a ratio of the second height to the third height assuming a value between 0.3 and 0.8, preferably between 0.4 and 0.7 and particularly preferably between 0.45 and 0.6.

7. The arrangement according to claim 1, wherein a radial extent of the collar member varies along the orbital direction.

8. A bearing component for an arrangement according to claim 1, wherein the bearing component has at least one first form-fitting means on the bearing component side.

9. A chassis component for an arrangement according to claim 1, wherein the chassis component has at least one first form-fitting means on the chassis component side (21).

10. A method for producing a bearing component according to claim 8, wherein the bearing component is produced by forming, in particular forging.

11. A method for producing a chassis component according to claim 9, wherein the chassis component is produced by forming or forging.
